(19) United States
(12) Patent Application Publication
(10) Pub. No.: US 2009/0024713 A1
(43) Pub. Date: Jan. 22, 2009

(54) MAINTAINING AVAILABILITY OF A DATA CENTER

(75) Inventors: James Strasenburgh, Pittsford, NY (US); David Bradley, Ionia, NY (US)

Correspondence Address: FISH & RICHARDSON PC, P.O. BOX 1022, MINNEAPOLIS, MN, 55440-1022, US

(73) Assignee: MetroSource Corp., Pittsford, NY (US)

(21) Appl. No.: 11/779,544

(22) Filed: Jul. 18, 2007

(51) Int. Cl. G06F 15/173

(52) U.S. Cl. 709/208

(57) ABSTRACT

A method is used with a data center that includes services that are interdependent. The method includes experiencing an event in the data center and, in response to the event, using a rules-based expert system to determine a sequence in which the services are to be moved, where the sequence is based on dependencies of the services, and moving the services from first locations to second locations in accordance with the sequence.

### TECHNICAL FIELD

This patent application relates generally to maintaining availability of a data center and, more particularly, to moving services of the data center from one location to another location in order to provide for relatively continuous operation of those services.

### BACKGROUND

A data center is a facility used to house electronic components, such as computer systems and communications equipment. A data center is typically maintained by an organization to manage operational data and other data used by the organization. Application programs (or simply, “applications”) run on hardware in a data center, and are used to perform numerous functions associated with data management and storage. Databases in the data center typically provide storage space for data used by the applications, and for storing output data generated by the applications.

Certain components of a data center may depend on one or more other components. For example, some data centers may be structured hierarchically, with low-level, or independent, components that have no dependencies, and higher-level, or dependent components, that depend on one or more other components. A database may be an example of an independent component in that it may provide data required by an application for operation. In this instance, the application is dependent upon the database. Another application may require the output of the first application, making the other application dependent upon the first application, and so on. As the number of components of a data center increases, the complexity of the data center's interdependencies can increase dramatically.

The situation is further complicated when a system is made up of multiple data centers, which may be referred to herein as groups of data centers. For example, there may be interdependencies among individual data centers in a group or among different groups of data centers. That is, a first data center may be dependent upon data from a second data center, or a first group upon data from a second group.

Organizations typically invest large amounts of time and money to ensure the integrity and functionality of their data centers. Problems arise, however, when an event occurs in a data center (or group) that adversely affects its operation. In such cases, the interdependencies associated with the data center can make it difficult to maintain the data center's availability, meaning, e.g., access to services and data.

### SUMMARY

This patent application describes methods and apparatus, including computer program products, for maintaining availability of a data center and, more particularly, for moving services of the data center from one location to another location in order to provide for relatively continuous operation of those services.

In general, this patent application describes a method for use with a data center comprised of services that are interdependent. The method includes experiencing an event in the data center and, in response to the event, using a rules-based expert system to determine a sequence in which the services are to be moved, where the sequence is based on dependencies of the services, and moving the services from first locations to second locations in accordance with the sequence. The method may also include one or more of the following features, either alone or in combination.

The data center may comprise a first data center. The first locations may comprise first hardware in the first data center, and the second locations may comprise second hardware in a second data center. The first location may comprise a first part of the data center and the second location may comprise a second part of the data center.

The services may comprise virtual machines. Network subnets of the services in the first data center may be different from network subnets of the first hardware. Network subnets of the services in the second data center may be different from network subnets of the second hardware.

Data in the first data center and the second data center may be synchronized periodically so that the services that are moved to the second data center are operable in the second data center. The rules-based expert system may be programmed by an administrator of the data center. The event may comprise a reduced operational capacity of at least one component of the data center and/or a failure of at least one component of the data center.

The foregoing method may be implemented as a computer program product comprised of instructions that are stored on one or more machine-readable media, and that are executable on one or more processing devices. The foregoing method may be implemented as an apparatus or system that includes one or more processing devices and memory to store executable instructions to implement the method.

In general, this patent application also describes a method of maintaining availability of services provided by one or more data centers. The method comprises modeling applications that execute in the one or more data centers as services. The services have different network subnets than hardware that executes the services. The method also includes moving the services, in sequence, from first locations to second locations in order to maintain availability of the services. The sequence dictates movement of independent services before movement of dependent services, where the dependent services depend on the independent services. A rules-based expert system determines the sequence. The method may also include one or more of the following features, either alone or in combination.

The first locations may comprise hardware in a first group of data centers and the second locations may comprise hardware in a second group of data centers. The second group of data centers may provide at least some redundancy for the first group of data centers. Moving the services may be implemented using a replication engine that is configured to migrate the services from the first locations to the second locations. A provisioning engine may be configured to imprint services onto hardware at the second locations. The services may be moved in response to a command that is received from an external source.

The foregoing method may be implemented as a computer program product comprised of instructions that are stored on one or more machine-readable media, and that are executable on one or more processing devices. The foregoing method may be implemented as an apparatus or system that includes one or more processing devices and memory to store executable instructions to implement the method.

The details of one or more examples are set forth in the accompanying drawings and the description below. Further features, aspects, and advantages will become apparent from the description, the drawings, and the claims.

### DESCRIPTION OF THE DRAWINGS

FIG. 1 is a block diagram of first and second data centers, with arrows depicting movement of services between the data centers.

FIG. 2 is block diagram of a machine included in a data center.

FIG. 3 is a flowchart showing a process for moving services from a first location, such as a first data center, to a second location, such as a second data center,

FIG. 4 is a block diagram showing multiple data centers, with arrows depicting movement of services between the data centers.

FIG. 5 is a block diagram showing groups of data centers, with arrows depicting movement of services between the groups of data centers.

### DETAILED DESCRIPTION

Described herein is method of maintaining availability of services provided by one or more data centers. The method includes modeling applications that execute in the one or more data centers as services, where the services have different network addresses than hardware that executes the services. The services are moved, in sequence, from first locations to second locations in order to maintain availability of the services. The sequence dictates movement of independent services before movement of dependent services. A rules-based expert system determines the sequence. Before describing details for implementing this method, this patent application first describes a way to model a data center, which may be used to support the method for maintaining data center availability.

The data center model is referred to as a Service Oriented Architecture (SOA). The SOA architecture provides a framework to describe, at an abstract level, services resident in a data center. In the SOA architecture, a service may correspond to, e.g., one or more applications, processes and/or data in the data center. In the SOA architecture, services can be isolated functionally from underlying hardware components and from other services.

Not all applications in a data center need be modeled as services. For example, a process that is an integral part of an operating system need not be modeled as a service. A database or Web-based application may be modeled as a service, since they contain business-level logic that should be isolated from data center infrastructure components.

A service is a logical abstraction that enables isolation between software and hardware components of a data center. A service includes logical components, which are similar to object-oriented software designs, and which are used to create interfaces that account for both data and its functional properties. Each service may be broken down into the following constituent parts: network properties, disk properties, computing properties, security properties, archiving properties, and replication properties.

The SOA architecture divides a data center into two layers. The lower layer includes all hardware aspects of the data center, including physical properties such storage structures, systems hardware, and network components. The upper layer describes the logical structure of services that inhabit the data center. The SOA architecture creates a boundary between these upper and lower layers. This boundary objectifies the services so that they are logically distinct from the underlying hardware. This reduces the chances that services will break or fail in the event of hardware architecture change. For example, when a service is enhanced, or modified, the service maintains clear demarcations with respect to how it operates with other systems and services throughout the data center.

In the SOA architecture, services have their own network address, e.g., Internet Protocol (IP) addresses, which are separate and distinct from IP addresses of the underlying hardware. These IP addresses are known as virtual IP addresses or service IP addresses. Generally, no two services share the same service IP address. This effectively isolates services from other services resident in the data center and creates, at the service layer, an independent set of interconnections between service IP addresses and their associated services. Service IP addresses make services appear substantially identical to hardware components of the data center, at least from a network perspective.

The basic premise is that in order to migrate a service across any TCP/IP (Transmission Control Protocol/Internet Protocol) network, a service incorporates a virtual TCP/IP address, which is referred to herein as the service IP address. To enable a service to be a self-standing entity, a service IP address includes both a host component (TCP/IP address) and a network component (TCP/IP subnet), which are different from the host and network components of the underlying hardware. By incorporating a subnet component into the service IP address, a service may be assigned its own, unique network. This enables any single service to move independently without requiring any other services to migrate along with the moved service. Thus, each service is effectively housed in its own dedicated network. The service can thus migrate from one location to any other location because the service owns both a unique TCP/IP address and its own TCP/IP subnet. Furthermore, by assigning a unique service IP address for each service, any hardware can take-over just that service, and not the properties of the underlying hardware.

Computer program(s)—e.g., machine-executable instructions—may be used to model applications as services and to move those services from one location to another. In this implementation, three separate computer programs are used: a services engine, a replication engine, and a provisioning engine. The services engine describes hardware, services properties and their mappings. The replication engine describes and implements various data replication strategies. The provisioning engine imprints services onto hardware. The operation of these computer programs is described below.

The services engine creates a mapping of hardware and services in groups of clusters. These clusters can be uniform services or be designed around a high-level business process, such as a trading system or Internet service. A service defines each application's essential properties. A service's descriptions are defined in such a way as to map out the availability of each service or group of services.

The SOA architecture uses the nomenclature of a “complex” to denote an integrated unit of hardware computing components that a service can use. In a services engine “config” file, there are “complex” statements, which compile knowledge about hardware characteristics of the data center, including, e.g., computers, storage area networks (SANs), storage arrays, and networking components. The services engine defines key properties for such components to create services that can access the components on different data centers, different groups of data centers, or different parts of the same data center. “Complex” statements also describe higher level constructs, such as multiple data center relationships and mappings of multiple complexes of systems and their services into a single complex comprised of non-similar hardware resources. For example, it is possible to have an “active-active” inter-data center design to support complete data center failover from a primary data center to a secondary data center, yet also describe how services can move to a tertiary emergency data center, if necessary.

In the services engine, a “bind” statement connects a service to underlying hardware, e.g., one or more machines. Services may have special relationships to particular underlying hardware. For example, linked services allow for tight associations between two services. These are used to construct replica associations used in file system and database replication between sites or locations, e.g., two different data centers. This allows database applications to reverse their replication directions between sites. Certain service components may be associated with a particular complex or site.

Another component of the services engine is the “service” statement. This describes how a service functions in the SOA architecture. Each service contains statements for declaring hardware resources on which the service depends. These hardware resources are categorized by network, process, disk, and replication.

The services engine includes a template engine and a runtime resolver for use in describing the services. These computer programs assist designers in describing the attributes of a service based upon other service properties so that several services can be created from a single description. During execution, service parameters are passed into the template engine to be instantiated. Templates can be constructed from other templates so that a unique service may be slightly different in its architecture, but can inherit a template and then extend the template. The template engine is useful in managing the complexity of data center designs, since it accelerates service rollouts and improves new service stabilization. Once a new class of service has been defined, it is possible to reuse the template and achieve substantially or wholly identical operational properties.

The runtime resolver, and an associated macro language, enable concise descriptions of how a service functions, and accounts for differences between sites (e.g., data centers) and hardware architectures. For example, during a site migration, a service may have a different disk subsystem associated with the service between sites. This cannot practically be resolved during compile time as the template may be in use across many different services. Templates, combined with the runtime resolver, assist in creating uniform associations in both design and runtime aspects of a data center.

The services engine cars be viewed, conceptually, as a framework to encapsulate data center technologies and to describe these capabilities up and into the service layer. The services engine incorporates other product's technologies and operating systems capabilities to build a comprehensive management system for the data center. The services engine can accomplish this because services are described abstractly relative to particular features of data center products. This allows the SOA architecture to account for fundamental technology changes and other data center product enhancements.

The ability to migrate a service to other nodes, complexes, and data centers may not be beneficial without the ability to maintain data accuracy. The replication engine builds upon the SOA architecture by creating an abstract description of replication properties that a service requires. This abstract description is integrated into the services engine and enables point-in-time file replication. This, coupled with the replication engine's knowledge of disk management subsystems of data centers, enables clean service migrations. One function of the replication engine is to abstract particular implementation methodologies and product idiosyncrasies so that different or new replication technologies can be inserted into the data center architecture. This enables numerous services to take advantage of its replication capabilities.

The replication engine differentiates data into two types: system-level data and service-level data. This can be an important distinction, since systems may have different backup acquirements than services. The services engine concentrates only on service data needs. There are two types of service-level data management implemented in the replication engine: replication that concentrates on ensuring that other targets or sites (e.g., data centers)) are capable of recovering services, and data archiving that concentrates on long term storage of service oriented data.

The provisioning engine is software to create and maintain uniform system data across a data center. The provisioning engine reads and interprets the services, including definitional statements in the services, and imprints those services onto appropriate hardware of a data center. The provisioning engine is capable of managing both layers of the data center, e.g., the lower (hardware) layer and the upper (services) layer. In this example, the provisioning engine is an object-oriented, graphical, program that groups hardware systems in an inheritance tree. Properties of systems at a high level, such as at a global system level, are inherited down into lower-level systems that can have specific needs, and eventually down into individual systems that may have particular uniqueness. The resulting tree is then mapped to a similar inheritance tree that is created for service definitions. Combining the two trees yields a mapping of how a system should be configured based upon the services being supported, the location of the system, and the type of hardware (e.g., machines) contained in a data center.

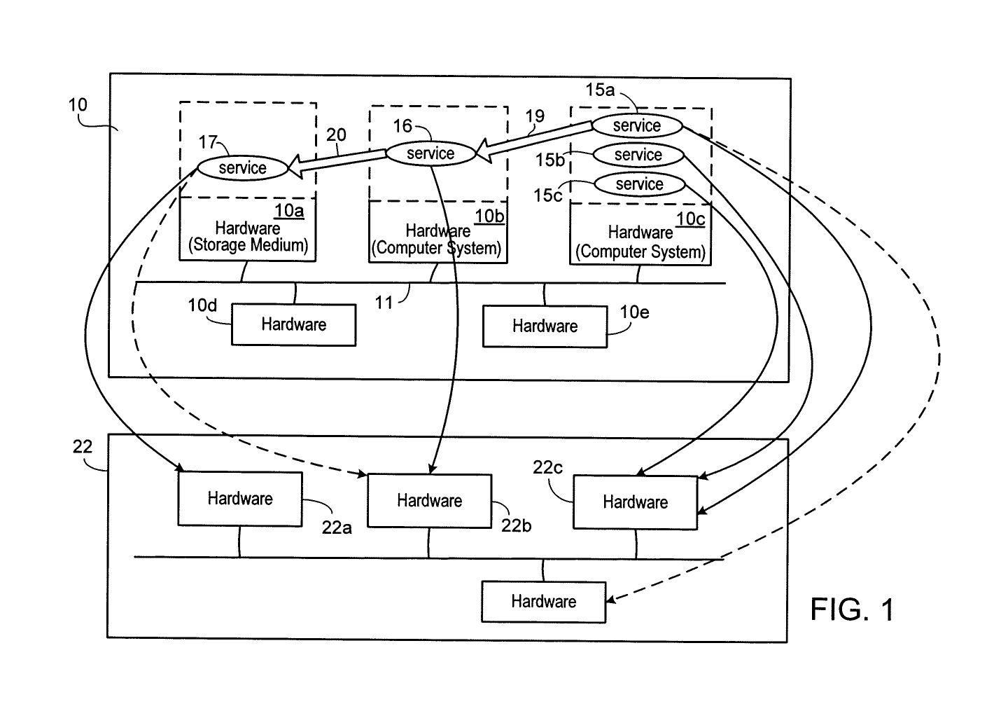

FIG. 1 shows an example of a data center 10. While only five hardware components are depicted in FIG. 1, data center 10 may include tens, hundreds, thousands, or more such components. Data center 10 may be a singular physical entity (e.g., located in a building or complex) or it may be distributed over numerous, remote locations. In this example, hardware components 10a to 10e communicate with each other and, in some cases, an external environment, via a network. 11. Network 11 may be an IP-enabled network, and may include a local area network (LAN), such as an intranet, and/or a wide area network (WAN), which may, or may not, include the Internet. Network 11 may be wired, wireless, or a combination of the two. Network 11 may also include part of the public switched telephone network (PSTN).

Data center 10 may include hardware components similar to a data center described in wikipedia.org, where the hardware components include “servers racked up into 19 inch rack cabinets, which are usually placed in single rows forming corridors between them. Servers differ greatly in size from 1U servers to huge storage silos which occupy many tiles on the floor. Some equipment such as mainframe computers and storage devices are often as big as the racks themselves, and are placed alongside them.” Generally, speaking, the hardware components of data center 10 may include any electronic components, including, but not limited to, computer systems, storage devices, and communications equipment. For example hardware components 10b and 10c may include computer systems for executing application programs (applications) to manage, store, transfer, process, etc. data in the data center, and hardware component 10a may include a storage medium, such as RAID (redundant array of inexpensive disks), for storing a database that is accessible by other components.

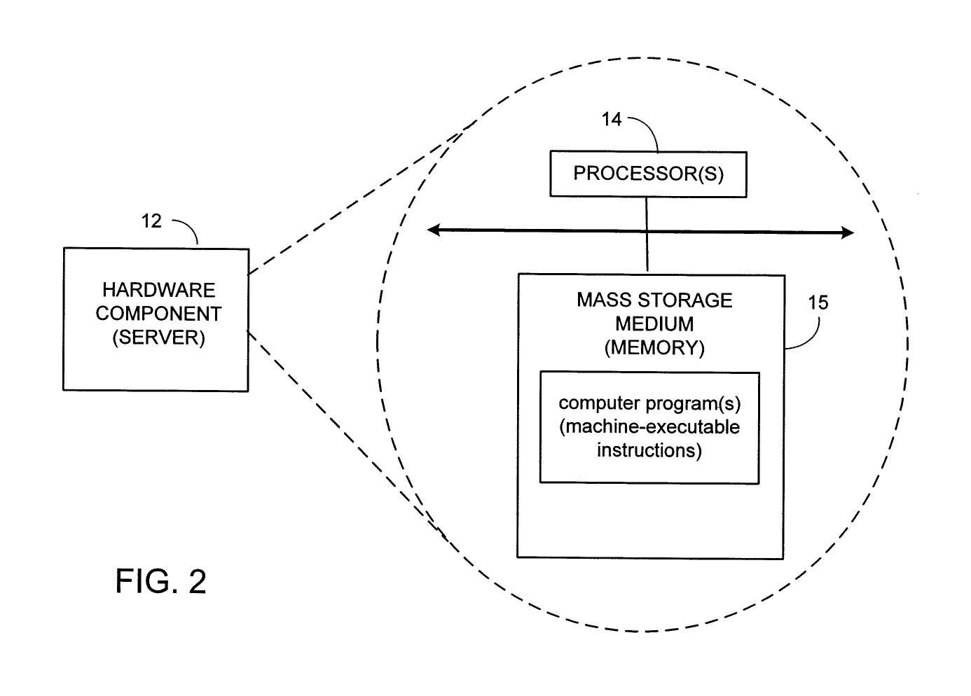

Referring to FIG. 2, a hardware component of data center 10 may include one or more servers, such as server 12. Server 12 may include one server or multiple constituent similar servers (e.g., a server farm). Although multiple servers may be used in this implementation, the following describes an implementation using a single server 12. Server 12 may be any type of processing device that is capable of receiving and storing data, and of communicating with clients. As shown in FIG. 2, server 12 may include one or more processor(s) 14 and memory 15 to store computer program(s) that are executable by processor(s) 14. The computer program(s) may be for maintaining availability of data center 10, among other things, as described, below. Other hardware components of data center may have similar, or different, configurations than server 12.

As explained above, applications and data of a data center may be abstracted from the underlying hardware on which they are executed and/or stored. In particular, the applications and data may be modeled as services of the data center. Among other things, they may be assigned separate service IP (e.g., Internet Protocol) addresses than the underlying hardware. In the example of FIG. 1, computer system 10c provides services 15a, 15c and 15e, computer system 10b provides service 16, and storage medium 10a provides service 17. That is, application(s) are modeled as services 15a, 15b and 15c in computer system 10b, where they are run; application(s) are modeled as service 16 in computer system 10b, where they are run; and database 10a is modeled as service 17 in a storage medium, where data therefrom is made accessible. It is noted that the number and types services depicted here are merely examples, and that more, less and/or different services may be run on each hardware component shown in FIG. 1.

The services of data center 10 may be interdependent. In this example, service 15a, which corresponds to an application, is dependent upon the output of service 16, which is also an application. This dependency is illustrated by thick arrow 19 going from service 15a to service 16. Also in this example, service 16 is dependent upon service 17, which is a database. For example, the application of service 16 may process data from database 17 and, thus, the application's operation depends on the data in the database. The dependency is illustrated by thick arrow 20 going from service 16 to service 17. Service 17, which corresponds to the database, is not dependent upon any other service and is therefore independent.

FIG. 1 also shows a second set of hardware 22. In this example, this second set of hardware is a second data center, and will hereinafter be referred to as second data center 22. In an alternative implementation, the second set of hardware may be hardware within “first” data center 10. In this example, everything said above that applies to the first data center 10 relating to structure, function, services, etc. may also apply to second data center 22. Second data center 22 contains hardware that is redundant, at least in terms of function, to hardware in second data center 22. That is, hardware in second data center 22 may be redundant in the sense that it is capable of supporting the services provided by first data center 10. That does not mean, however, that the hardware in second data center 22 must be identical in terms of structure to the hardware in first data center 10, although it may be in some implementations.

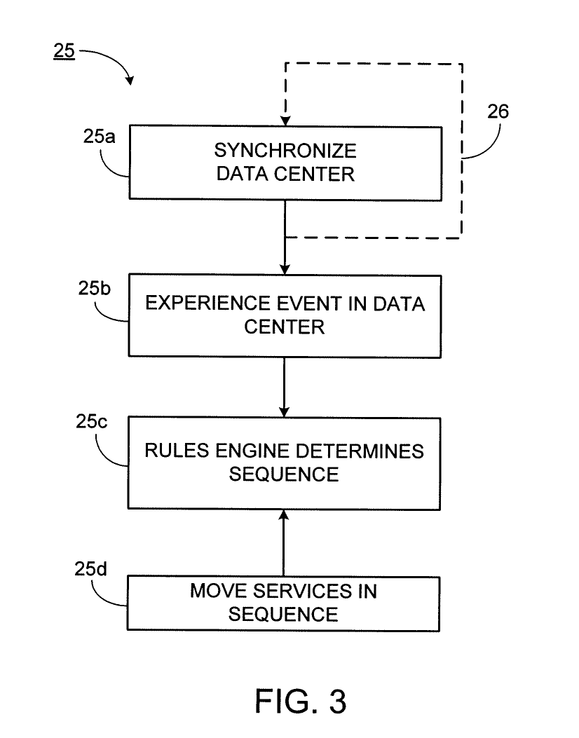

FIG. 3 shows a process 25 for maintaining relatively high availability of data center 10. What this means is that process 25 is performed so that the services of data center 10 may remain functional, at least to some predetermined degree, following an event in the data center, such as a fault that occurs in one or more hardware or software components of the data center. This is done by transferring those services to second data center 22, as described below. Prior to performing process 25, data center 10 may be modeled as described above. That is, applications and other non-hardware components, such as data, associated with the data center are modeled as services.

Process 25 may be implemented using computer program(s), e.g., machine-executable instructions, which may be stored for each hardware component of data center 10. In one implementation, the computer program(s) may be stored on each hardware component and executed on each hardware component. In another implementation, computer program(s) for a hardware component may be stored on machine(s) other than the hardware component, but may be executed on the hardware component. In another implementation, computer program(s) for a hardware component may be stored on, and executed on, machine(s) other than the hardware component. Such machine(s) may be used to control the hardware component in accordance with process 25. Data center 10 may be a combination of the foregoing implementations. That is, some hardware components may store and execute the computer program(s); some hardware components may execute, but not store, the computer program(s); and some hardware components may be controlled by computer program(s) executed on other hardware component(s).

Corresponding computer program(s) may be stored for each hardware component of second data center 22. These computer program(s) may be stored and/or executed in any of the manners described above for first data center 10.

The computer program(s) for maintaining availability of data center 10 may include the services, replication and provisioning engines described herein. The computer program(s) may also include a rules-based expert system. The rules-based expert system may include a rules engine, a fact database, and an inference engine.

In this implementation, the rules-based expert system may be implemented using JESS (Joint Expert Specification System), which is a CLIPS (C Language Integrated Production System) derivative implemented in Java and is capable of both forward and backward chaining capability. This implementation uses the forward chaining capabilities. A rules based, forward chaining, expert system starts with an aggregation of facts (the facts database) and process the facts to reach a conclusion. Here, the facts may include information identifying components in a datacenter, such as systems, storage arrays, networks, services, processes, and ways to process work including techniques for encoding other properties necessary to support a high availability infrastructure. In addition to these facts, events such as systems outages, introduction of new infrastructure components, systems architectural reconfigurations, application alterations requiring changes to how service use datacenter infrastructure, etc. are also facts in the expert system. The facts are fed through one or more of rules describing relationships and properties to identify, such as where a service or group of services, should be run, including sequencing requirements (described below). The expert system inference engine then determines proper procedures for correctly recovering a loss of service and, e.g., how to start-up and shut-down services or groups of services which is all part of a high availability implementation. The rules-based, expert system uses “declarative” programming techniques, meaning that the programmer does not need to specify how a program is to achieve its goal at the level of an algorithm.

The expert system has the ability to define multiple solutions or indicate no solution to a failure event by indicating a list of targets to which services should be remapped. For example, if a component of a Web service fails in a data center, the expert system is able to deal with the fault (which is an event that is presented to the expert system) and then list, e.g., all or best possible alternative solution sets for remapping the services to a new location. More complex examples may occur when central storage subsystems, multiples, and combinations of services fail, since it may become more important, in these cases, for the expert system to identify recoverability semantics.

Each hardware component executing the computer program(s) may have access to a copy of the rules-based expert system and associated rules. The rules-based expert system may be stored on each hardware component or stored in a storage medium that is external, but accessible, to a hardware component. The rules may be programmed by an administrator of data center 10 in order, e.g., to meet a predefined level of availability. For example, the rules may be configured to ensure that first data, center 10 runs at at least 70% capacity; otherwise, a fail-over to second data center 22 may occur. In one real-world example, the rules may be set to certify a predefined level of availability for a stock exchange data center in order to comply with Sarbanes-Oxley requirements. Any number of rules may be executed by the rules-based expert system. As indicated above, the number and types of rules may be determined by the data center administrator.

Examples of rules that may be used include, but are not limited to, the following. Data center 10 may include a so-called “hot spare” for database 10a, meaning that data center 10 may include a duplicate of database 10a, which may be used in the event that database 10a fails or is otherwise unusable. In response to an event, such as a network failure, which hinders access to data center 10, all services of data center 10 may move to second data center 22. The services move in sequence, where the sequence includes moving independent services before moving dependent services and moving dependent services according to dependency, e.g., moving service 16 before service 15a, so that dependent services can be brought-up in their new locations in order (and, thus, relatively quickly). The network event may be an availability that is less than a predefined amount, such as 90%, 80%, 70%, 60%, etc.

Referring to FIG. 3, process 25 includes synchronizing (25a) data center 10 periodically, where the periodicity is represented by the dashed feedback arrow 26. Data center 10 (the first data center) may be synchronized to second data center 22. For example, all or some services of first data center 10 may be copied to second data center 22 on a daily, weekly, monthly, etc. basis. The services may be copied wholesale from first data center 10 or only those services, or subset(s) thereof, that differ from those already present on second data center 22 may be copied. These functions may be performed via the replication and provisioning engines described above.

Data center 10 experiences (25) an event. For example, data center 10 may experience a failure in one or more of its hardware components that adversely affects its availability. The event may cause a complete failure of data center 10 or it may reduce the availability to less than a predefined amount, such as 90%, 80%, 70%, 60% etc. Alternatively, the failure may relate to network communications to, from and/or within data center 10. For example, there may be a Telco failure that prevents communications between data center 10 and the external environment. The type and severity of the event that must occur in order to trigger the remainder of process 25 may not be the same for every data center. Rather, as explained above, the data center administrator may program the triggering event, and consequences thereof, in the rules-based expert system. In one implementation, the event may be a command that is provided by the administrator. That is, process 25 may be initiated by the administrator, as desired.

The rules-based expert system detects the event and determines (25c) a sequence by which services of first data center 10 are to be moved to second data center 22. In particular, the rules-based expert system moves the services according to predefined rule(s) relating to their dependencies in order to ensure that the services are operable, as quickly as possible, when they are transferred to second data center 22. In this implementation, the rules-based expert system dictates a sequence whereby service 17 is moved first (to component 22a), since it is independent. Service 16 moves next (to component 22b), since it depends on service 17. Service 15a moves next (to component 22c), since it depends on service 16, and so on until all services (or as many services as are necessary) have been moved. Independent services may be moved at any time and in any sequence. The dependencies of the various services may be programmed into the rules-based expert system by the data center administrator; the dependencies of those services may be determined automatically (e.g., without administrator intervention) by computer program(s) running in the data center and then programmed automatically; or the dependencies may be determined and programmed through a combination of manual and automatic processes.

Process 25 moves (25d) services from first data center 10 to second data center 22 in accordance with the sequence dictated by the rules-based expert system. Corresponding computer program(s) on second data center 25 receive the services, install the services on the appropriate hardware, and bring the services to operation. The dashed arrows of FIG. 1 indicate that services may be moved to different hardware components. Also, two different services may be moved to the same hardware component.

In one implementation, the replication engine is configured to migrate the services from hardware on first data center 10 to hardware on second data center 22, and the provisioning engine is configured to imprint the services onto the hardware at second data center 22. Thereafter, second data center 22 takes over operations for first data center 10. This includes shutting down components data center (or a portion thereof) in the appropriate sequence and bringing the components back-up in the new data center in the appropriate sequence, e.g., shutting down dependent components first according to their dependencies then shutting-down independent components. The reverse order (or close thereto) may be used to when bringing the components back-up in the new data center.

Each hardware component in each data center includes an edge router program that posts service IP addresses directly into the routing fabric of the internal data center network and/or networks connecting two or more data centers. The service IP addresses are re-posted every 30 seconds in this implementation (although any time interval may be used). The edge router program of each component updates its routing tables accordingly. The expert system experiences an event (e.g., identifies a problem) in a data center. In one example, the expert system provides an administrator with an option to move services from one location to another, as described above. Assuming that the services are to be moved, each service is retrieved via its service IP address, each service IP address is torn-down in sequence, and the services with their corresponding IP addresses are mapped into a new location (e.g., a new data center) in sequence.

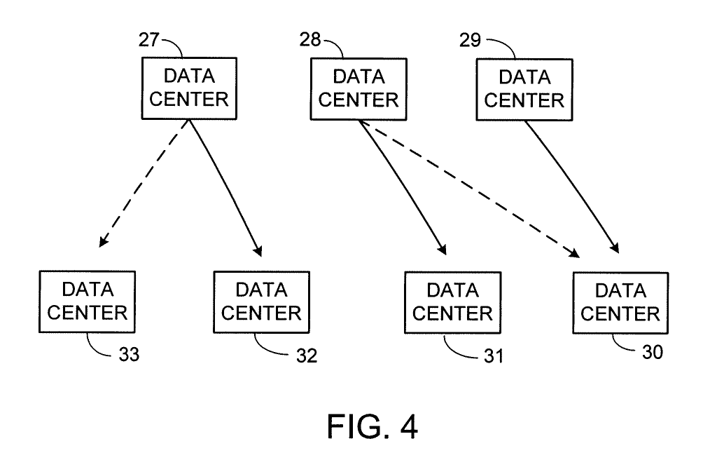

Process 25 has been described in the context of moving services of one data center 10 to another data center 27. Process 25, however, may be used to move services of a data center to two different data centers, which may or may not be redundant. FIG. 4 shows this possibility in the context of data centers 27, 28 and 29, which may have the same, or different, structure and function as data center 10 of FIG. 1. Likewise, process 25 may be used to move the services of two data centers 28 and 29 to a single data center 30 and, at the same time, to move the service of one data center 28 to two different data centers 30 and 31. Similarly, process 25 may be used to move services of one part of a data center (e.g., a part that has experienced an error event) to another part, or parts, of a the same data center (e.g., a part that has not been affected by the error event).

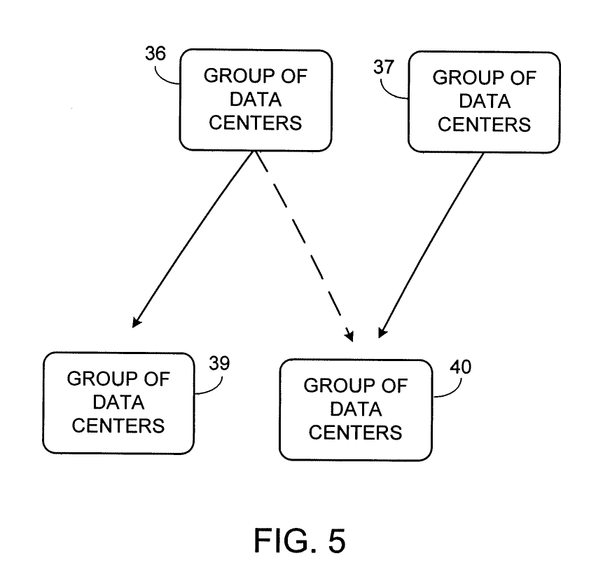

Process 25 may also be used to move services from one or more data center groups to one or more other data center groups. In this context, a group may include, e.g., as few as two data centers up to tens, hundreds, thousands or more data, centers. FIG. 5 shows movement of services from group 36 to groups 39 and 40, and movement of services from group 37 to group 40. The operation of process 25 on the group level is the same as the operation of process 25 on the data center level. It is noted, however, that, on the group level, rules-based expert systems in the groups may also keep track of dependencies among data centers, as opposed to just hardware within the data center. This may further be extended to keeping track of dependencies among hardware in one data center (or group) vis-à-vis hardware in another data center (or group). For example, hardware in one data center may be dependent upon hardware in a different data center. The rules-based expert system keeps track of this information and uses it when moving services.

Process 25 has been described above in the context of the SOA architecture. However, process 25 may be used with “service” definitions that differ from those used in the SOA architecture. For example, process 25 may be used with hardware virtualizations. An example of a hardware virtualization is a virtual machine that runs an operating system on underlying hardware. More than one virtual machine may ran on the same hardware, or a single virtual machine may run on several underlying hardware components (e.g., computers). In any case, process 25 may be used to move virtual machines in the manner described above. For example, process 25 may be used to move virtual machines from one data center to another data center in order to maintain availability of the data center. Likewise, process 25 may be used to move virtual machines from part of a data center to a different part of a same data center, from one data center to multiple data centers, from multiple data centers to one data center, and/or from one group of data centers to another group of data centers in any manner.

The SOA architecture may be used to identify virtual machines and to model those virtual machines as SOA services in the manner described herein. Alternatively, the virtual machines may be identified beforehand as services to the program(s) that implement process 25. Process 25 may then execute in the manner described above to move those services (e.g., the virtual machines) to maintain data center availability.

It is noted that process 25 is not limited to use with services defined by the SOA. architecture or to using virtual machines as services. Any type of logical abstraction, such as a data object, may be moved in accordance with process 25 to maintain a level of data center availability in the manner described herein.

Described below is an example of maintaining availability of a data center in accordance with process 25. In this example, the rules-based expert system applies artificial intelligence (AI) techniques, here a rules-based expert system, to manage and describe complex services or virtual host interdependencies for sets of machines or group of clusters to a forest of clusters and data centers. The rules-based expert system can provide detailed process resolution, in a structured way, to interrelate all systems (virtual or physical) and all services under a single or multiple Expert Continuity Engine (ECE).

In a trading infrastructure or stock exchange, there are individual components. There may be multiple systems that orders will visit as part of an execution. These systems have implicit dependencies between many individual clusters of services. There may be analytic systems, fraud detection systems, databases, order management systems, back office services, electronic communications networks (ECNs), automated trading systems (ATSs), clearing subsystems, real-time market reporting subsystems, and market data services that comprise the active trading infrastructure. In addition to these components, administrative services and systems such as help desk programs, mail subsystems, backup and auditing, security and network management software are deployed along-side the core trading infrastructure. There are also interdependencies from outside services—for example other exchanges or the like. Furthermore, some of these services are often not co-resident, but are housed across multiple data centers—even spanning across continents, which adds to very high levels of complexity. Process 25 enables such services to recover from a disaster or system failure.

Process 25, through its ECE, focuses on the large-scale picture of managing services in a data center. By generating a series of rules and AI techniques, a complete description of how services are inter-related and ordered, and how they use the hardware infrastructure in the data centers, along with mappings of systems and virtual hosts are generated to describe how to retarget specific data center services or complete data centers. In addition, the ECE understands how these interrelationships behave across a series of failure conditions, e.g., network failure, service outage, database corruption, storage subsystem (SAN or storage array failure), system, virtual host, or infrastructure failures from human-caused accidents, or Acts of God. Process 25 is thus able to take this info account when moving data center services to appropriate hardware. For example, in the case of particularly fragile services, it may be best to move them to robust hardware.

Referring to the example of a trading infrastructure, if a central storage subsystem fails, the process 25, including the ECE, establishes fault-isolation through a rule set and agents that monitor specific hardware components within the data center (these agents may come from other software products and monitoring packages). Once the ECE determines what components are faulted, the ECE can combine the dependency/sequencing rules to stop or pause (if required) services that are still operative, but that have dependencies on failed services that are, in turn, dependent upon the storage array. These failed services are brought to an offline state. The ECE determines the best systems, clusters, and sites on which those services should be recomposed, as described above. The ECE also re-sequences startup of failed subsystems (e.g., brings the services up and running in appropriate order), and re-enables survived services to continue operation.

The processes described herein and their various modifications (hereinafter “the processes”), are not limited to the hardware and software described above. All or part of the processes can be implemented, at least in part, via a computer program product, e.g., a computer program tangibly embodied in an information carrier, such as one or more machine-readable media or a propagated signal, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the processes can be performed by one or more programmable processors executing one or more computer programs to perform the functions of the calibration process. All or part of the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Components of different embodiments described herein may be combined to form other embodiments not specifically set forth above. Other embodiments not specifically described herein are also within the scope of the following claims.

What is claimed is:

1. A method for use with a data center comprised of services that are interdependent, the method comprising:
experiencing an event in the data center; and
in response to the event:
using a rules-based expert system to determine a sequence in which the services are to be moved, the sequence being based on dependencies of the services; and
moving the services from first locations to second locations in accordance with the sequence.

2. The method of claim 1, wherein the data center comprises a first data center, the first locations comprise first hardware in the first data center, and the second locations comprise second hardware in a second data center.

3. The method of claim 2, wherein network subnets of the services in the first data center are different from network subnets of the first hardware, and network subnets of the services in the second data center are different from network subnets of the second hardware.

4. The method of claim 1, further comprising:
synchronizing data in the first data center and the second data center periodically so that the services that are moved to the second data center are operable in the second data center.

5. The method of claim 1, wherein the rules-based expert system is programmed by an administrator of the data center.

6. The method of claim 1, wherein the event comprises a reduced operational capacity of at least one component of the data center.

7. The method of claim 1, wherein the event comprises a failure of at least one component of the data center.

8. The method of claim 1, wherein the first location comprises a first part of the data center and the second location comprises a second part of the data center.

9. The method of claim 1, wherein the services comprise virtual machines.

10. A method of maintaining availability of services provided by one or more data centers, the method comprising:
modeling applications that execute in the one or more data centers as services, the services having different network subnets than hardware that executes the services; and
moving the services, in sequence, from first locations to second locations in order to maintain availability of the services, the sequence dictating movement of independent services before movement of dependent services, where the dependent services depend on the independent services;
wherein a rules-based expert system determines the sequence.

11. The method of claim 10, wherein the first locations comprise hardware in a first group of data centers and the second locations comprise hardware in a second group of data centers, the second group of data centers providing at least some redundancy for the first group of data centers.

12. The method of claim 10, wherein moving the services is implemented using a replication engine that is configured to migrate the services from the first locations to the second locations, and using a provisioning engine that is configured to imprint services onto hardware at the second locations.

13. The method of claim 10, wherein the services are moved in response to a command that is received from an external source.

14. One or more machine-readable media storing instructions that are executable to move services of a data center, where the services are interdependent, the instructions for causing one or more processing devices to:
recognize an event in the data center; and
in response to the event:
use a rules-based expert system to determine a sequence in which the services are to be moved, the sequence being based on dependencies of the services; and
move the services from first locations to second locations in accordance with the sequence.

15. The one or more machine-readable media of claim 14, wherein the data center comprises a first data center, the first locations comprise first hardware in the first data center, and the second locations comprise second hardware in a second data center.

16. The one or more machine-readable media of claim 15, wherein network subnets of the services in the first data center are different from network subnets of the first hardware, and network subnets of the services in the second data center are different from network subnets of the second hardware.

17. The one or more machine-readable media of claim 14, further comprising instructions for causing the one or more processing devices to;
synchronize data in fee first data center and the second data center periodically so that the services that are moved to the second data center are operable in the second data center.

18. The one or more machine-readable media of claim 14, wherein the rules-based expert system that is programmed by an administrator of the data center.

19. The one or more machine-readable media of claim 14, wherein the event comprises a reduced operational capacity of at least one component of the data center.

20. The one or more machine-readable media of claim 14, wherein the event comprises a failure of at least one component of the data center.

21. The one or more machine-readable media of claim 14, wherein the first location comprises a first part of the data center and the second location comprises a second part of the data center.

22. The one or more machine-readable media of claim 14, wherein the services comprise virtual machines.

23. One or more machine-readable media storing instructions that are executable to maintain availability of services provided by one or more data centers, the instructions for causing one or more processing devices to:
model applications that execute in the one or more data centers as services, the services having different network subnets than hardware that executes the services; and
move the services, in sequence, from first locations to second locations in order to maintain availability of the services, the sequence dictating movement of independent services before movement of dependent services, where the dependent services depend on the independent services;
wherein a rules-based expert system determines the sequence.

24. The one or more machine-readable media of claim 23, wherein the first locations comprise hardware in a first group of data centers and the second locations comprise hardware in a second group of data centers, the second group of data centers providing at least some redundancy for the first group of data centers.

25. The one or more machine-readable media of claim 23, wherein moving the services is implemented using a replication engine that is configured to migrate the services from the first locations to the second locations, and using a provisioning engine that is configured to imprint services onto hardware at the second locations.

26. The one or more machine-readable media of claim 23, wherein the services are moved in response to a command that is received from an external source.
